(19) United States
(12) Patent Application Publication
(10) Pub. No.: US 2023/0367322 A1
(43) Pub. Date: Nov. 16, 2023

(54) AREA RECOGNITION SYSTEM, AREA RECOGNITION METHOD, AND PROGRAM

(71) Applicant: TOYOTA JIDOSHA KABUSHIKI KAISHA, Toyota-shi (JP)

(72) Inventors: Yuta ITOZAWA, Nagoya-shi (JP); Kunihiro Iwamoto, Nagakute-shi (JP)

(73) Assignee: TOYOTA JIDOSHA KABUSHIKI KAISHA, Toyota-shi (JP)

(21) Appl. No.: 18/306,367

(22) Filed: Apr. 25, 2023

(30) Foreign Application Priority Data
May 16, 2022 (JP) 2022-080179

(51) Int. Cl. G05D 1/02

(52) U.S. Cl. CPC G05D 1/0214; G05D 1/0259

(57) ABSTRACT

A polarity of the magnetic member on an upper surface side thereof is a first magnetic pole. The robot includes a first magnetic sensor, a second magnetic sensor, a safety apparatus configured to suppress an operation of the robot in response to the detection of the first magnetic pole, and a recognition unit configured to recognize a movement of the robot between the different travel areas by detecting each of the one or more magnetic members. The first magnetic sensor and the second magnetic sensor are disposed at different positions from each other in a width direction of the robot. Each of the one or more magnetic members is disposed so as to be detected by the second magnetic sensor and not detected by the first magnetic sensor, when the movement of the robot in the width direction between the different travel areas is limited.

### CROSS REFERENCE TO RELATED APPLICATIONS

This application is based upon and claims the benefit of priority from Japanese patent application No. 2022-080179, filed on May 16, 2022, the disclosure of which is incorporated herein in its entirety by reference.

### BACKGROUND

The present disclosure relates to an area recognition system, an area recognition method, and a program.

In some cases, a track for driverless vehicles may be divided into high-speed sections and low-speed sections. Japanese Unexamined Patent Application Publication No. H05-189028 discloses a technique for providing N-pole magnets and N-pole magnets between low-speed sections and high-speed sections to recognize areas.

### SUMMARY

A robot may include a safety apparatus that operates in response to a detection of magnetism. In such cases, a magnetic member installed to recognize an area could cause the robot's safety apparatus to malfunction.

The present disclosure has been made to solve such a problem, and an object thereof is to provide an area recognition system, an area recognition method, and a program that can recognize a travel area while preventing a safety apparatus from malfunctioning.

In an aspect, an area recognition system for recognizing a travel area of a robot includes:

one or more magnetic members including a first magnetic member disposed between different travel areas.

A polarity of the first magnetic member on an upper surface side thereof is a first magnetic pole, the first magnetic pole being one of an N-pole and an S-pole, and
the robot comprises:
   a first magnetic sensor;
   a second magnetic sensor;
   a safety apparatus configured to suppress an operation of the robot in response to the detection of the first magnetic pole using the first magnetic sensor; and
   a recognition unit configured to recognize a movement of the robot between the different travel areas by detecting each of the one or more magnetic members using the second magnetic sensor,
the first magnetic sensor and the second magnetic sensor are disposed at different positions from each other in a width direction of the robot, and
each of the one or more magnetic members is disposed so as to be detected by the second magnetic sensor and not detected by the first magnetic sensor, when the movement of the robot in the width direction between the different travel areas is limited.

In another aspect, an area recognition method for recognizing a travel area of a robot,
one or more magnetic members including a first magnetic member disposed between different travel areas,
a polarity of the first magnetic member on an upper surface side thereof being a first magnetic pole, the first magnetic pole being one of an N-pole and an S-pole,
the robot including:
   a first magnetic sensor;
   a second magnetic sensor; and
   a safety apparatus configured to suppress an operation of the robot in response to the detection of the first magnetic pole using the first magnetic sensor,
the first magnetic sensor and the second magnetic sensor being disposed at different positions from each other in a width direction of the robot, and
each of the one or more magnetic members being disposed so as to be detected by the second magnetic sensor and not detected by the first magnetic sensor, when the movement of the robot in the width direction between the different travel areas is limited, the area recognition method including:
recognizing, by the robot, a movement between the different travel areas by detecting each of the one or more magnetic members using the second magnetic sensor.

In another aspect, a program causes a computer to execute the above area recognition method.

According to the present disclosure, it is possible to provide an area recognition system, an area recognition method, and a program that can recognize a travel area while preventing a safety apparatus from malfunctioning.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is an overview diagram showing a configuration of an area recognition system according to a first embodiment;

FIG. 2 is an overview diagram showing specific examples of high-speed travel area and a low-speed travel area;

FIG. 3 is a block diagram showing functions of a robot according to the first embodiment;

FIG. 4 is a diagram for explaining positions of first and second magnetic sensors; and

FIG. 5 is an overview diagram showing a configuration of an area recognition system according to related art.

### DESCRIPTION OF EMBODIMENTS

Although the present disclosure is described below through the embodiment of the disclosure, the disclosure in the claims is not limited to the following embodiment. Moreover, not all of the configurations described in the embodiment are essential as means to solve the problem.

### First Embodiment

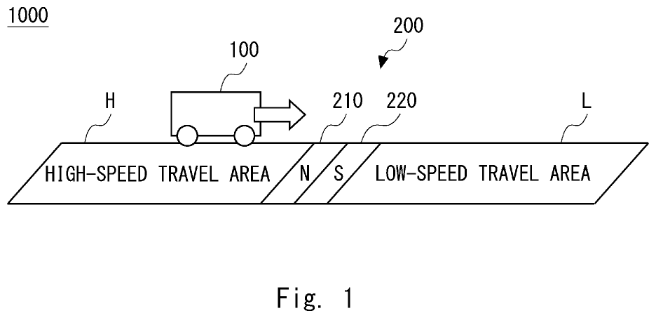

An area recognition system according to a first embodiment is described below with reference to the drawings. FIG. 1 is an overview diagram showing a configuration of an area recognition system 1000 according to the first embodiment. The area recognition system 1000 is a system for recognizing a travel area of a robot 100.

The area recognition system 1000 includes the robot 100. The travel area of the robot 100 includes a high-speed travel area H and a low-speed travel area L. The robot 100 may be a conveying robot that conveys a load. The area recognition system 1000 may further include a server (not shown) that generates a traveling route for the robot 100. The area recognition system 1000 may also include a system in which processing is completed within the robot 100.

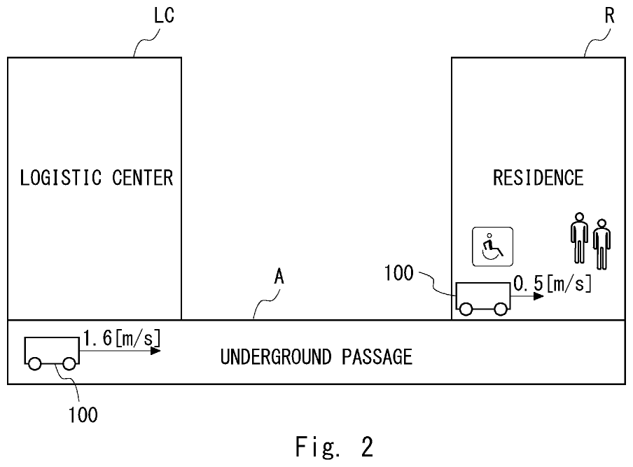

One example of the high-speed travel area H and the low-speed travel area L is described with reference to FIG. 2. It is assumed that the robot 100 is a conveyance robot. The robot 100 conveys a load from a logistics center LC to a residence R. The residence R is a human habitation and includes a passage shared by humans with the robot 100. An underground passage A is provided between the logistics center LC and the residence R. The maximum speed of the robot 100 is limited to, for example, 1.6 m/s in the underground passage A and 0.5 m/s in the residence R. In such a case, the underground passage A is the high-speed travel area H and the residence R is the low-speed travel area L.

FIG. 2 shows only one example of the high-speed travel area H and the low-speed travel area. While the speed of the robot 100 needs to be limited in the low-speed travel area L, the low-speed travel area L and the high-speed travel area H can be any. For example, the high-speed travel area H can be a roadway, and the low-speed travel area L can be a sidewalk.

Returning to FIG. 1, the description is continued. The area recognition system 1000 includes one or more magnetic members 200. Each of one or more magnetic members 200 includes a magnetic member 210. The magnetic member 210 is also referred to as a first magnetic member. The polarity of the magnetic member 210 on an upper surface side thereof is a first magnetic pole, which is one of the N- and S-poles. In the following, the first magnetic pole is described mainly as being the N-pole, but the first magnetic pole may be the S-pole. The one or more magnetic members 200 are disposed between the high-speed travel area H and the low-speed travel area L. Each of the one or more magnetic members 200 may be a magnetic tape or a magnet.

As shown in FIG. 1, each of the one or more magnetic members 200 may further include a magnetic member 220. The magnetic member 220 is also referred to as a second magnetic member. The magnetic members 210 and 220 are arranged along a direction in which the robot 100 travels (this direction is hereinafter referred to as a traveling direction). The arrows in FIG. 1 indicate the traveling direction of the robot 100. Specifically, the polarity of the magnetic member 220 on the upper surface side thereof is a second magnetic pole, which is different from the first magnetic pole.

Note that each of the one or more of the magnetic members 200 needs not include the magnetic member 220. Also, the magnetic members 210 and 220 may have the same polarity on the upper surface side thereof, and the strength of the magnetic poles of the magnetic members 210 and 220 may be different from each other. Furthermore, each of the one or more magnetic members 200 may include three or more magnetic members.

Each of the one or more magnetic members 200 is used by the robot 100 to recognize the travel area. In FIG. 1, the magnetic member 210 is arranged on the side of the high-speed travel area H, and the magnetic member 220 is arranged on the side of the low-speed travel area L.

A third magnetic member (not shown) is disposed in the low-speed travel area L or the high-speed travel area H. The third magnetic member is used to operate the safety apparatus. The polarity of the third magnetic member on the upper surface side thereof is the first magnetic pole (e.g., the N-pole).

It is assumed that the movement of the robot 100 in a width direction is restricted between the high-speed travel area H and the low-speed travel area L. For example, a boundary between the high-speed travel area H and the low-speed travel area L may be provided in a narrow passage compared to the width of the robot 100 or in the entrance or exit of an elevator.

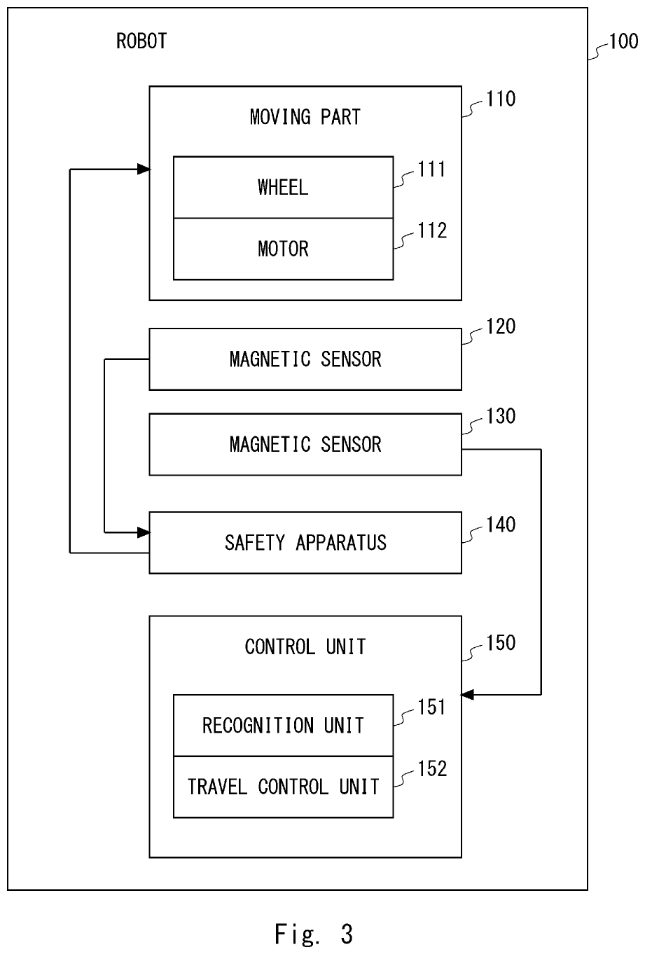

FIG. 3 is a block diagram showing a functional configuration of the robot 100. The robot 100 includes a moving part 110, a magnetic sensor 120, a magnetic sensor 130, the safety apparatus 140, and a control unit 150. The robot 100 may further include a robot arm for moving a load.

The moving part 110 includes a wheel 111 and a motor 112 for rotating the wheel 111. The motor 112 rotates the wheel 111 through a reduction gear or the like. The motor 112 can move the robot 100 to a specified position by rotating the wheel 111 in response to a control signal from the control unit 150. The wheel 111 also stops or decelerates according to an operation of the safety apparatus 140 described later.

The magnetic sensor 120 detects the first magnetic pole (the N-pole). The magnetic sensor 120 is also referred to as a first magnetic sensor. The number of magnetic sensors 120 may be plural. The detection result of the magnetic sensor 120 is used to operate the safety apparatus 140. The plurality of magnetic sensors 120 may be provided on the outer periphery (e.g., four corners) of the bottom surface of the robot 100. The magnetic sensor 120 outputs the detection result to the safety apparatus 140.

The magnetic sensor 130 detects both the N-pole and S-pole. The magnetic sensor 130 is provided, for example, at the center of the bottom surface of the robot 100. The magnetic sensor 130 is also referred to as a second magnetic sensor. The magnetic sensor 130 outputs the detection result to control unit 150.

The magnetic sensor 120 and the magnetic sensor 130 are disposed at different positions from each other in the width direction of the robot 100. The magnetic member 210 and the magnetic member 220 are then disposed so that they are detected by the magnetic sensor 130 and not detected by the magnetic sensor 120. Specific arrangements of the magnetic sensor 120 and the magnetic sensor 130 will be described later.

The safety apparatus 140 suppresses the operation of the robot 100 by detecting the first magnetic pole (e.g., the N-pole) using the magnetic sensor 120. The safety apparatus 140 may slow down or stop the rotation of the wheel 111 when the first magnetic pole is detected. The safety apparatus 140 may be implemented as a function of the control unit 150 described later. A third magnetic member (not shown) is disposed in the low-speed travel area L or the high-speed travel area H to increase the safety of the robot 100 to travel. For example, if the third magnetic member is disposed in front of the stairs, the area recognition system 1000 can prevent the robot 100 prevented from falling.

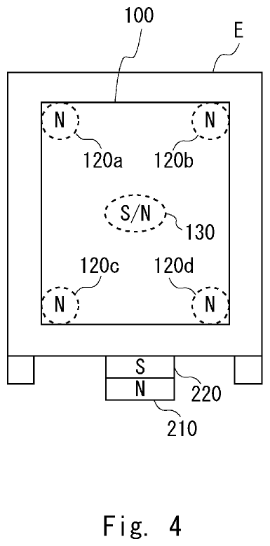

Next, the positions of the magnetic sensors 120 and the magnetic sensor 130 are described with reference to FIG. 4. The magnetic sensors 120a, 120b, 120c, and 120d are specific examples of the magnetic sensor 120 described above. FIG. 4 shows an example in which the robot 100 includes four magnetic sensors 120a, 120b, 120c, and 120d, but the number of magnetic sensors 120 is not limited to four.

FIG. 4 is a top view of the robot 100, and the positions of the magnetic sensors 120a, 120b, 120c, 120d, and 130 in the horizontal plane are indicated by dotted lines. The robot 100 is positioned in an elevator E. The magnetic member 210 and the magnetic member 220 are disposed at the entrance of the elevator E.

If the magnetic pole for operating the safety apparatus 140 is the N-pole, the magnetic sensors 120a, 120b, 120c, and 120d are magnetic sensors capable of detecting the N-pole. The magnetic sensor 130 is a magnetic sensor capable of detecting both the N- and S-poles.

The magnetic sensors 120a, 120b, 120c, and 120d are provided at four corners of the bottom surface of the robot 100. The magnetic sensors 120a and 120b are disposed at different positions in the width direction of the robot 100. The magnetic sensor 130 is provided at the center of the bottom surface of the robot 100.

As described above, the magnetic member 210 and the magnetic member 220 are disposed so that they are detected by the magnetic sensor 130 and not detected by the magnetic sensor 120. In the width direction of the robot 100, the magnetic sensor 130 is disposed between the magnetic sensor 120a and the magnetic sensor 120b. In the width direction of the robot 100, the length of the magnetic member 210 and the length of the magnetic member 220 are shorter than the distance between the magnetic sensor 120a and the magnetic sensor 120b. In other words, the widths of the magnetic member 210 and the magnetic member 220 are sufficiently narrow.

When the robot 100 moves outside the elevator E, the magnetic sensor 130 detects the magnetic member 210 and the magnetic member 220, and the control unit 150, which will be described later, recognizes the travel area. At this time, the magnetic sensors 120a, 120b, 120c, and 120d do not detect the magnetic member 210, and thus the safety apparatus 140 does not malfunction.

Returning to FIG. 3, the description is continued. The control unit 150 includes a processor and a memory. The control unit 150 includes a recognition unit 151 and a travel control unit 152. Each function of the control unit 150 may be implemented by loading a program (not shown) into the memory and executing the program by the processor.

The recognition unit 151 recognizes that the robot 100 has moved between different travel areas by detecting each of the magnetic members 200 using the magnetic sensor 130. For example, when the magnetic sensor 130 detects the first magnetic pole and detects the second magnetic pole, the recognition unit 151 recognizes that the robot 100 has moved from the high-speed travel area H to the low-speed travel area L. When the magnetic sensor 130 detects the second magnetic pole and detects the first magnetic pole, the recognition unit 151 recognizes that the robot 100 has moved from the low-speed travel area H to the high-speed travel area L.

The travel control unit 152 controls the movement of the robot 100 based on the area recognition result of the recognition unit 151. Specifically, the travel control unit 152 controls the robot 100 to travel at high speed when the robot 100 travels in the high-speed travel area H and at low speed when the robot 100 travels in the low-speed travel area L. The travel control unit 152 may control the movement of the robot 100 so as not to exceed the maximum speed in the travel area of the robot 100. The travel control unit 152 may further include the function of generating a traveling route for the robot 100.

Next, the area recognition method according to the first embodiment is described with reference to FIG. 1. It is assumed that the first magnetic pole is the N-pole, and the second magnetic pole is the S-pole. First, the case where the robot 100 moves from the high-speed travel area H to the low-speed travel area L will be described. The arrow indicates a direction in which the robot 100 moves.

First, the robot 100 passes over the magnetic member 210 and the magnetic member 220. The magnetic sensor 130 detects the N-pole and detects the S-pole. Next, the recognition unit 151 of the control unit 150 recognizes the movement from the high-speed travel area H to the low-speed travel area L. The travel control unit 152 of the robot 100 may start the low-speed traveling according to the recognition by the recognition unit 151.

As described above, the magnetic member 210 and the magnetic member 220 are disposed so as to be detected by the magnetic sensor 130 and so as not to be detected by the magnetic sensor 120. Therefore, when the robot 100 passes over the magnetic member 210, the safety apparatus 140 does not operate.

Next, a case in which the robot 100 moves from the low-speed travel area L to the high-speed travel area H will be described. First, the robot 100 passes over the magnetic members 210 and 220. The magnetic sensor 120 detects the S-pole and detects the N-pole. Next, the recognition unit 151 of the control unit 150 recognizes a movement from the low-speed travel area L to the high-speed travel area H.

According to first embodiment, the travel area can be recognized while preventing the malfunction of the safety apparatus.

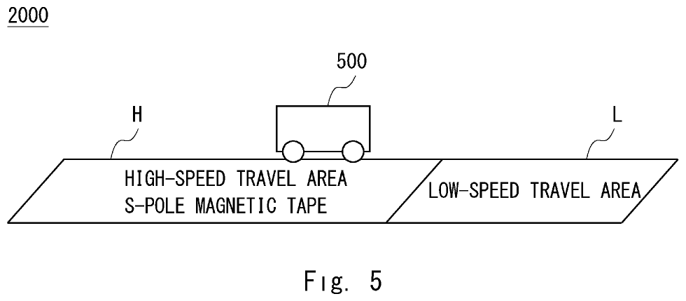

In the first embodiment, it is not necessary to dispose a magnetic member on the entire surface of the low-speed travel area L or the high-speed travel area H. FIG. 5 is an overview diagram showing an area recognition system 2000 according to related art, and shows what the inventor has considered. The area recognition system 2000 includes a robot 500.

A magnetic member (e.g., magnetic tape) having, for example, the S-pole is disposed on the entire surface of the high-speed travel area H of the area recognition system 2000. When the robot 500 is detecting the S-pole, it recognizes that it is traveling in the high-speed travel area H, whereas when the robot 500 is not detecting the S-pole, it recognizes that it is traveling in the low-speed travel area L. The robot 500 operates the safety apparatus by detecting, for example, a magnetic member (not shown) having the N-pole.

Since the area recognition system 2000 does not perform area recognition using the N-pole, the area can be recognized while preventing malfunction of the safety apparatus. However, the area recognition system 2000 has a problem that a magnetic member must be disposed on the entire surface of the low-speed travel area L or the high-speed travel area H. In the area recognition system 1000 according to the first embodiment, there is no need to dispose a magnetic member on the entire surface of the low-speed travel area L or the high-speed travel area, and this system has an advantage that the cost is low compared with related art.

In the above example, the program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

It should be noted that the present disclosure is not limited to the above embodiment and can be changed as appropriate without departing from the purport.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An area recognition system for recognizing a travel area of a robot, the area recognition system comprising:
one or more magnetic members including a first magnetic member disposed between different travel areas, wherein
a polarity of the first magnetic member on an upper surface side thereof is a first magnetic pole, the first magnetic pole being one of an N-pole and an S-pole,
the robot comprises:
a first magnetic sensor;
a second magnetic sensor;
a safety apparatus configured to suppress an operation of the robot in response to the detection of the first magnetic pole using the first magnetic sensor; and
a recognition unit configured to recognize a movement of the robot between the different travel areas by detecting each of the one or more magnetic members using the second magnetic sensor,
the first magnetic sensor and the second magnetic sensor are disposed at different positions from each other in a width direction of the robot, and
each of the one or more magnetic members is disposed so as to be detected by the second magnetic sensor and not detected by the first magnetic sensor, when the movement of the robot in the width direction between the different travel areas is limited.

2. The area recognition system according to claim 1, wherein
the number of the first magnetic sensors is more than one, and
the plurality of first magnetic sensors include two magnetic sensors disposed at different positions in the width direction of the robot,
the second magnetic sensor is disposed between the two magnetic sensor in the width direction of the robot, and
a length of each of the one or more magnetic members is shorter than a distance between the two magnetic sensors in the width direction of the robot.

3. The area recognition system according to claim 1, wherein
the one or more magnetic members are disposed at an entrance of an elevator.

4. The area recognition system according to claim 1, wherein
the travel area of the robot includes a high-speed travel area and a low-speed travel area,
a third magnetic member for operating the safety apparatus is disposed in the high-speed travel area and the low-speed travel area, and
a polarity of the third magnetic member on the upper surface side thereof is the first magnetic pole.

5. An area recognition method for recognizing a travel area of a robot,
one or more magnetic members including a first magnetic member disposed between different travel areas,
a polarity of the first magnetic member on an upper surface side thereof being a first magnetic pole, the first magnetic pole being one of an N-pole and an S-pole,
the robot comprising:
a first magnetic sensor;
a second magnetic sensor; and
a safety apparatus configured to suppress an operation of the robot in response to the detection of the first magnetic pole using the first magnetic sensor,
the first magnetic sensor and the second magnetic sensor being disposed at different positions from each other in a width direction of the robot, and
each of the one or more magnetic members being disposed so as to be detected by the second magnetic sensor and not detected by the first magnetic sensor, when the movement of the robot in the width direction between the different travel areas is limited, the area recognition method comprising:
recognizing, by the robot, a movement between the different travel areas by detecting each of the one or more magnetic members using the second magnetic sensor.

6. A non-transitory computer readable medium storing a program for causing a computer to execute the area recognition method according to claim 5.
